(19) United States
(12) Patent Application Publication
(10) Pub. No.: US 2026/0034563 A1
(43) Pub. Date: Feb. 5, 2026

(54) MINERAL WOOL INSULATION

(71) Applicant: KNAUF INSULATION, Vise (BE)

(72) Inventor: Etienne DHEUR, Mount Saint Guibert (BE)

(21) Appl. No.: 18/998,253

(22) PCT Filed: Jul. 26, 2023
(86) PCT No.: PCT/EP2023/070774

§ 371 Date: Jan. 24, 2025

(30) Foreign Application Priority Data
Jul. 26, 2022 (GB) 2210892.2

(51) Int. Cl. B05D 1/02

(52) U.S. Cl. CPC B05D 1/02; B05D 2202/00; B05D 2203/30; B05D 2320/00

(57) ABSTRACT

Glass wool insulation comprises:
a collection of intermingled glass fibres in the form of glass wool, the glass wool having a structure formed from the intermingled glass fibres and air-filled interstices between the intermingled glass fibres, the glass fibres being present in the glass wool insulation in a quantity of at least 70% wt;
optionally an organic binder present in a quantity of less than 12% wt, the organic binder being distributed within the glass wool structure and serving to retain the collection of intermingled glass fibres in the form of glass wool; and
a fire-resistance enhancer notably selected from the group consisting of: hydromagnesite, magnesium hydroxide, brucite, huntite, dolomite, calcium carbonate and combination thereof, the fire-resistance enhancer being present in an amount of 1-15% wt and being distributed within the glass wool structure.

This invention relates to mineral wool insulation, in particular mineral wool insulation which provides both thermal insulation and fire-resistance, notably for building applications.

Where mineral wool insulation is intended to provide both thermal insulation and fire-resistance, the use of rock wool (also known as stone wool) is traditionally preferred over glass wool. For example, where it is desired to enhance the fire resistance of a building structure, for example the concrete ceiling of an underground car park or a structural metal beam, stone wool, for example stone wool insulation panels or a sprayed layer of stone wool insulation is commonly used. The higher softening point of rock wool fibres compared to glass wool fibres renders rock wool insulation better suited to withstand exposure to high temperatures and/or fire conditions. Fire tests often require exposure of mineral wool insulation to temperatures of at least 850° C. or at least 1000° C.; such temperatures are below the softening point of typical stone wool fibres but above the softening temperature of typical glass wool fibres.

US 2007/0105467 A1 discloses dispersion of a fire retardant agent which contains carbon black and a metal hydroxide (preferably magnesium hydroxide or aluminium trihydroxide) in a binder used to form a glass fibre veil (referred to in the document as a “fiberglass mat”). The glass fibre veil incorporating the fire retardant agent is bonded to a fiberglass insulation batt, for example a fiberglass duct liner or fiberglass HVAC equipment liner so that the fiberglass insulation batt forms a self-supporting glass wool insulating panel having the glass fibre veil (incorporating the fire retardant agent) provided as a facing. In this arrangement, the fire retardant agent is present only in the glass fibre veil which forms the facing of the glass wool insulation and not within the glass wool structure of the glass wool insulation. US 2007/0105467 A1 teaches that, in its arrangement, the magnesium hydroxide exhibits flame retardant properties by releasing water through endothermic decomposition at 330° C., about 100° C. higher than the decomposition temperature of aluminium trihydroxide. Accordingly, it teaches that magnesium hydroxide is preferred over aluminium trihydroxide when the processing temperature associated with the manufacture of the fire retardant glass fibre veil fiberglass batt on which the veil is provided as a facing are above 230° C. The use of glass fibre veils to provide a facing for glass wool duct liners is well known; the teaching of US 2007/0105467 A1 to provide a fire retardant agent in such a facing is consistent with a desire to reduce risks of initiation and propagation of flames in duct liners. The requirements for duct liners are incomparable with the requirements for enhancing the fire enhancement of building structures. Furthermore, it would be thought that once the facing disclosed in US 2007/0105467 A1 had be raised to a temperature above that of the endothermic decomposition of its flame retarding agent then the technical effect of its flame retarding agent would be exhausted.

One aim of the present invention is to provide improve mineral wool insulation which provides both thermal insulation and fire-resistance, notably for building applications.

In accordance with one of its aspects, the present invention provides glass wool insulation as defined in claim 1. Additional aspects of the invention are defined in independent claims. The dependent claims define preferred and/or alternative embodiments.

One aspect of the present invention is based on the realisation that the fire resistance of glass wool insulation can be significantly improved by the incorporation of the fire-resistance enhancer(s) disclosed herein. This can be done to such an extent as to allow the enhanced glass wool insulation to be used, for example, in applications for which traditional glass wool is inappropriate. The enhanced glass wool insulation can provide improved thermal conductivity (lambda (λ)) and/or reduced density compared with equivalent stone wool insulation.

As used herein, the term “glass wool insulation” means a collection of intermingled glass fibres in the form of glass wool, the glass wool having a structure formed from the intermingled glass fibres and air-filled interstices between the intermingled glass fibres, the glass fibres being present in the glass wool insulation in a quantity of at least 70% wt with respect to the glass wool insulation. The glass wool insulation of the present invention is thus not comparable with, for example, glass fibre veils, glass fibre reinforced resins, glass fibre reinforced plasterboard or glass fibre reinforced wood boards. The glass wool insulation preferably comprises at least 70% wt, preferably at least 80% wt, more preferably at least 85% wt of the glass fibres; the balance is preferably made up by the combination of the organic binder (when present), the fire-resistance enhancer and the intumescent fire-resistant component (when used), along with any additives that enhance the properties of the glass wool insulation (for example dedusting oils, antistatic agents, binder coupling agents). Thus, the glass wool insulation product preferably consists essentially of the glass fibres, the fire-retardant component, the optional binder, the optional intumescent fire-resistant component. As used herein, the term “consists essentially of” is intended to limit the scope of a claim to the specified materials or steps and those that do not materially affect the basic and novel characteristic(s) of the claimed invention. Thus, for example, where the glass wool insulation product consists essentially of the glass fibres, the fire-retardant component, the optional binder and the optional intumescent fire-resistant component, additives that enhance the properties of the glass wool insulation (for example dedusting oils, antistatic agents, binder coupling agents) may also be present.

As used herein, the term “% wt” means percent by weight and, unless otherwise stated, refers to “dry weight” i.e. the weight excluding the weight of any water present. Thus, for example, where the glass wool insulation is a sprayed layer of glass wool insulation, the % wt of the glass fibres with respect to the glass wool insulation is calculated without taking into account any water that is used to project the fibres towards a surface; this is because, subsequent to being sprayed, a sprayed layer of glass wool insulation will dry out and in normal use will no longer retain the water that was used as part of the spraying process. Similarly, where the binder is present as a binder solution, the % wt is calculated on the basis of the “dry weight” of the binder i.e. without the water present in the binder solution; similarly, this is because, when the binder is cured and in the form in which it is present in normal use, the water previously present in the binder solution will no longer be present. However, where the fire-resistance enhancer (or any other component) comprises water of crystallisation that will remain present during normal use of the glass wool insulation, this water of crystallisation is included in the calculation of % wt; this is because such water of crystallisation will remain present in the glass wool insulation during normal use, at least until the glass wool insulation is subjected to fire conditions or conditions representative of building fire resistance tests.

The glass wool insulation preferably has a thickness of at least 30 mm; more preferably at least 50 mm. The thickness of the glass wool insulation is preferably less than 250 mm, more preferably or less than 200 mm. The glass wool insulation preferably has a density of at least 15 kg/m³; more preferably, it has a density of least 20 kg/m³, most preferably at least 30 kg/m³, even most preferably at least 40 kg/m³. The density of the glass wool insulation is preferably less than 100 kg/m³, more preferably less than 80 kg/m³, most preferably less than 70 kg/m³. Preferably, the density of the glass wool insulation is in the range 30-80 kg/m³, more preferably in the range 30-70 kg/m³. The preferred thicknesses and densities and preferred combinations provide good thermal and fire resistance properties without excessive weight which complicates installation.

The fire-resistance enhancer is distributed within the glass wool structure as opposed, for example, to being incorporated in the composition of the glass fibres themselves. Notably, the fire-resistance enhancer is arranged between the intermingled fibres of the glass. When the glass wool insulation comprises the organic binder, the fire-resistance enhancer may be combined with or provided within the binder. For example, the fire-resistance enhancer may be combined with the organic binder to form a binder mixture comprising the fire-resistance enhancer, and the binder mixture may then be applied to the glass fibres, notably as an aqueous binder solution carrying the fire-resistance enhancer. This facilitates application of the fire-resistance enhancer. In addition, incorporation of the fire-resistance enhancer in the binder of the glass wool insulation facilitates a desirable distribution of the fire-resistance enhancer within the structure of the glass wool.

Without wishing to be bound by theory, it is believed that the fire-resistance enhancer works in the following way. When an exposed surface of the glass wool insulation is subjected to conditions representative of building fire resistance tests, increase in the temperature of the glass fibres at an exposed surface of the glass wool insulation causes glass fibres at the exposed surface to soften and agglomerate into a softened mass of glass. This softened mass of glass forms around the exposed glass fibres and also around adjacent glass fibres in the glass wool insulation which have been shielded from the heat source by the exposed glass fibres. Some of the fire-resistant enhancer that is present in the glass wool structure, including fire-resistant enhancer that is present in parts of the glass wool insulation that has been shielded from the heat source by the exposed glass fibres (notably in parts of the glass wool insulation behind the exposed surface of the glass wool insulation which has not been directly exposed to the heat source), is incorporated into this agglomeration of softened glass. This incorporated fire-resistant enhancer subsequently releases a gas due to the temperature to which it is subjected within the agglomeration of softened glass and this gas release acts as a foaming agent which causes foaming of the agglomeration of softened glass. The foaming of the softened glass reduces the tendency of the softened glass to detach itself from the rest of the glass wool insulation, probably due to its reduced density and/or increased viscosity. The tendency of the foamed mass to remain attached to the glass wool insulation for longer means that this foamed mass of softened glass continues to shield the remaining glass wool insulation from direct exposure to the heat source, thus delaying the time before the remaining glass wool insulation is directly exposed to the heat source. When the foamed mass of softened glass does start to flow and/or detach itself from the remaining glass wool insulation, the process repeats with respect to the newly exposed surface of the glass wool insulation. It is also believed that incorporation of the fire-resistant enhancer into the softened glass increases the softening temperature or viscosity of the softened glass, probably by altering the chemical composition of the softened glass, and that this reduces the tendency of the softened glass to detach itself from the rest of the glass wool insulation.

The glass fibres are notably glass fibres having a softening point which is less than 750° C., the softening point of the glass fibres may be in the range 600-750° C., preferably in the range 650-750° C. Use of glass fibres having such a softening point facilitates fiberisation of the fibres during their manufacture. As used herein, the term “softening point” means the temperature at which the glass fibres deforms under their own weight and which occurs at a viscosity of 107.6 poise (106.6 Pa·s). Preferably the softening point is determined in accordance with International standards ISO 7884-1 (entitled “Principles for determining viscosity and viscometric fixed points”) and ISO 7884-2 (entitled “Determination of viscosity by rotation viscometers”); alternatively, it may be determined in accordance with International standards ISO 7884-1 and ISO 7884-6 (entitled “Determination of softening point”). The versions of the standards are those in force on 1 Jul. 2022.

The glass fibres preferably have a composition comprising:
55 to 75 wt % SiO₂, and
5 to 20 wt % of the combination of Na₂O and K₂O, and
5 to 20 wt % of the combination of CaO and MgO, and
0 to 5 wt % Al₂O₃, and
0 to 2 wt % total iron expressed as Fe₂O₃, and
an alkali/alkaline-earth ratio which is >1.
   This provides glass wool fibres as opposed, for example, to stone wool fibres.
   The glass fibres are preferably bio-soluble and more preferably are Note Q compliant. As used herein, the term “bio-soluble” means that the glass fibres have sufficient solubility in lung fluid to avoid any potential health hazard if inhaled. The term “Note Q compliant” as used herein means that the glass fibres meet the requirements of Note Q of the Directive of the Commission of the European Union 97/69/EC of 5 Dec. 1997 so as to be exempt from labelling requirements under this Directive.

The fire-resistance enhancer is preferably distributed homogeneously throughout the glass wool insulation; this provides approximately the same amount of fire-resistance enhancer throughout the entire thickness of the glass wool insulation. A suitable amount of the fire-resistance enhancer is thus available throughout the thickness of the glass wool insulation so as to be available for incorporation into a softening mass of glass that forms at any point in the thickness of the glass wool insulation. For example, the variation in the amount of fire-resistance enhancer present in the glass wool insulation at a major surface of the glass wool insulation that will first be directly exposed to fire conditions, at the other major surface of the glass wool insulation and at a position in the thickness of the glass wool insulation mid-way between the two major surfaces, is preferably less than 10%, more preferably less than 5%.

The fire-resistance enhancer is preferably present in the glass wool insulation in an amount which is 2% wt, more preferably 3% wt with respect to the glass fibres; this provides a sufficient quantity for the fire-resistance enhancer to be effective. The fire-resistance enhancer is preferably present in the glass wool insulation in an amount which is ≤12% wt, more preferably ≤10% wt with respect to the glass fibres; greater quantities of fire-resistance enhancer are not thought to provide commensurate benefit. A quantity of about 3% wt has been shown to be effective and it is believed that the effect may be achieved with less; thus, the fire-resistance enhancer may be present in the glass wool insulation in an amount of 2-10% wt with respect to the glass fibres.

The fire-resistance enhancer may be selected from the group consisting of: hydromagnesite, magnesium hydroxide, brucite, huntite, dolomite, calcium carbonate and combination thereof. The preferred fire-resistance enhancer is magnesium hydroxide. Each of these compounds releases a gas at a temperature which is appropriate for enhancing the fire-resistance of the glass wool insulation, notably as set out in Table 1:

TABLE 1

| Fire-resistance | | Decomposition | Gas |
|---|---|---|---|
| enhancer | Formula | T° (° C.) | release |
| Hydromagnesite | 4(MgCO₃)•(Mg(OH)₂)•4 | 200-300° (275°) | H₂O |
| | H₂O | 300-500° | CO₂ |
| Magnesium | Mg(OH)₂ | 400-600° | H₂O |
| hydroxide | | | |
| (Brucite) | | | |
| Huntite | CaMg₃ (CO₃)₄ | 550° | CO₂ |
| | | 690° | CO₂ |
| Dolomite | CaMg(CO₃)₂ | 775°-840° | CO₂ |
| Calcium | CaCO₃ | 750° | CO₂ |
| Carbonate | | | |

Preferably, the fire-resistance enhancer does not comprise halogen(s) or phosphorus; likewise, the glass wool insulation preferably does not comprise halogen(s) or phosphorus. This avoids the use of traditional halogen and phosphorous containing fire-retardants and their associated disadvantages.

When the glass wool insulation is a sprayed layer of glass wool insulation or a self-supporting panel, the glass wool insulation preferably comprises the optional organic binder, the organic binder being distributed within the glass wool structure and serving to retain the collection of intermingled glass fibres in the form of glass wool. It is particularly surprising that desired levels of fire-resistance can be achieved thanks to the invention despite the use of an organic binder to retain the collection of intermingled glass fibres in the form of glass wool. It would have been thought that decomposition of the organic binder when subjecting the glass wool insulation to fire conditions would entrain disintegration and failure of the glass wool insulation. When an organic binder is present, is it preferably present in an amount ≥2 wt %, more preferably 4 wt % with respect to the glass fibres; such quantities confer desirable mechanic properties. When an organic binder is present, it is preferably present in an amount ≤10 wt %, more preferably ≤8 wt % with respect to the glass fibres; greater quantities do not provide significant improvements in mechanical properties and add unnecessary combustible material to the glass wool insulation.

Preferably, the fire-resistance enhancer is provided in the form of particles; this has been found to be an effective form for the fire-resistance enhancer and facilities incorporation of the fire-resistance enhancer using standard manufacturing processes. Alternatively, the fire-resistance enhancer may be provided in the form of flakes. Particularly when the fire-resistance enhancer is provided in the form of particles or flakes, the particles or flakes may be provided with a coating, preferably an anti-clumping coating. Such a coating may reduce the tendency of the particles or flakes to agglomerate or clump together, notably when the particles or flakes are carried by a binder or sprayed with water. The anti-clumping coating may be a water-repellent coating; it is believed that such a water-repellent coating reduces a tendency to clump by reducing a risk of water adsorption.

In addition to the fire-resistance enhancer, the glass wool insulation may comprise an intumescent fire-resistant component, notably an intumescent fire-resistant component selected from the group consisting of: expandable graphite, expandable vermiculite, expandable perlite and combination thereof. Without wishing to be bound by theory, it is believed that the intumescent fire-resistant component provides a form of expanded heat resistant coating when exposed to fire conditions and that this coating acts as a heat and radiation shield at the exposed surface of the glass wool insulation. Preferably, the intumescent fire-resistant component also fragilizes the molten mass of glass so that smaller portions of the (foamed) molten glass flow or are detached from the glass fibre insulation. This heat and radiation shield provides an additional delay to the effects of exposure to fire conditions (for example about 20 minutes), this additional delay can be useful in combination with the fire-resistance enhancer to achieve a desired level of fire resistance, for example, to achieve a fire-resistance of 1 hour. Interesting, it has been observed that the effect of the intumescent fire-resistant component is significantly less in the absence of the fire-resistance enhancer. The intumescent fire-resistant component when present is preferably present in the glass wool insulation in an amount ≥2 wt %, more preferably ≥3 wt % and even more preferably ≥4 wt % with respect to the glass fibres; such quantities confer desirable properties. The intumescent fire-resistant component when present is preferably present in the glass wool insulation in an amount ≤10 wt %, more preferably ≤8 wt % and even more preferably ≤6 wt % with respect to the glass fibres; greater quantities do not provide commensurate improvements.

Preferably, the intumescent fire-resistant component is provided in the form of particles (particularly for expandable perlite) or in the form of flakes (particularly for expandable graphite and expandable vermiculite); this has been found to be an effective form for the intumescent fire-resistant component and facilities incorporation.

Particularly when the intumescent fire-resistant component is provided in the form of particles or in the form of flakes, at least 50% wt the intumescent fire-resistant component may have a particle size of at least 30 mesh, preferably of at least 32 mesh, more preferably of least 34 mesh.

It has been found that the technical effects associated with the intumescent fire-resistant component is greater with larger particles or flakes; thus it is preferable that at least 70% wt, at least 80% wt at least 90% wt or at least 95% wt of the intumescent fire-resistant component has a particle size of at least 30 mesh, preferably 32 mesh, more preferably 34 mesh.

The aforementioned preferred sizes and/or size distributions are particularly preferred when the intumescent fire-resistant component is expandable graphite.
The particle size of the particles or flakes are determined with sieves conforming to EN 933-1.

The intumescent fire-resistant component may be selected from the group consisting of: expandible graphite, expandable vermiculite, expandable perlite and combination thereof. Properties of these material are set out in Table 2.

TABLE 2

| Intumescent | | | |
|---|---|---|---|
| fire-resistant | | | |
| component | T° Expansion | | Expansion |
| Expandable | 150 to >250° | C. | 30-400 cm³/g |
| Graphite | | | (100 to 300x) or |
| | | | 30-500 cm³/g |
| Expandable | 850-900° | C. | 6-30 cm³/g (up |
| Perlite | | | to 20x) |
| Expandable | 800 to 1000° | C. | 12 cm³/g (6 to 8x) |
| Vermiculite | | | |

Preferably, the intumescent fire-resistant component is expandible graphite, more preferably expandible graphite in the form of flakes, and most preferably expandible graphite in the form of flakes in which at least 80% of the flakes have a particle size of at least 30 mesh. Graphite flakes, notably graphite flakes having a particle size of at least 30 mesh, are preferred, both for size and for ease of incorporation within the glass wool structure of the glass wool insulation. Particularly when the intumescent fire-resistant component is expandible graphite, the expandable graphite may have an expansion of at least 300 cm³/g, preferably of at least 400 cm³/g.

Preferably, the glass wool insulation comprises 2-8 wt % of the fire-resistance enhancer with respect to the glass fibres and 2-8% wt of the intumescent fire-resistant component with respect to the glass fibres.

Preferably, the fire-resistance enhancer is provided in the form of particles; this has been found to be an effective form for the fire-resistance enhancer and facilities incorporation of the fire-resistance enhancer using standard manufacturing processes. Alternatively, the fire-resistance enhancer may be provided in the form of flakes.

In a preferred embodiment, the glass wool insulation comprises, and preferably consists essentially of
a) a collection of intermingled glass fibres in the form of glass wool, the glass wool having a structure formed from the intermingled glass fibres and air-filled interstices between the intermingled glass fibres, the glass fibres being present in the glass wool insulation in a quantity of at least 70% wt with respect to the glass wool insulation;
b) at least one fire-resistant enhancer selected from the list consisting of magnesium hydroxide and calcium carbonate, preferably in which the total amount of the fire-resistant enhancer is in the range 2-10% wt with respect to the glass fibres; and
c) an intumescent fire-resistant component which is expandable graphite, preferably present in the range 2-8% wt with respect to the glass fibres; and
d) an organic binder, notably present in the range 4-10% wt with respect to the glass fibres the organic binder being distributed within the glass wool structure and serving to retain the collection of intermingled glass fibres in the form of glass wool.

The glass wool insulation may have a fire reaction classification of at least B, preferably at least A2 and more preferably A1 according to European Standard EN 13501-1. The glass wool insulation may have or provide a fire resistance of at least 30 minutes, preferably at least 45 minutes, and more at least 60 minutes determined according to EN 1363-1 General requirements and the appropriate fire resistance standard selected as a function of the building structure, type of element (e.g. fire doors) or support surface to which the glass wool insulation is applied, notably to one of the standards selected from the EN 1364 series (notably EN 1364-1), the EN 1365 series (notably EN 1365-1, EN 1365-2, EN 1365-3 or EN 1365-4) and the EN 13381 series (notably EN 13381-3, EN 13381-4, EN 13381-5, EN 13381-6 or EN 13381-7).

The glass wool insulation may have a lambda value (measured at 10° C.) in the range 30-38 mW/m·K., preferably in the range 30-35 mW/m·K; this provides desirable levels of thermal insulation.

The glass wool insulation may be secured to a support structure of a building, for example to the underside of a horizontal concrete slab forming the ceiling of an underground car park or to a structural metal beam of a building.

The glass wool insulation may be a sprayed layer of glass wool insulation. A sprayed layer of glass wool insulation is adapted to cover a larger surface than a single insulating panel or even a plurality of juxtapositioned panels, without interruption. For example, a sprayed layer may be arranged to cover the interface between a wall and an adjacent ceiling without interruption or an entire ceiling or other support structure without interruption. The optional organically binder is preferably included for a sprayed layer of glass wool insulation and the binder for a sprayed layer of glass wool insulation is preferably selected from a PVOH, and EVA copolymer and a PVAC copolymer.

Thus, in accordance with another aspect, the present invention provides a method of providing glass wool insulation as disclosed herein which is a sprayed layer of glass wool insulation, the method comprising:
introducing the glass fibres, notably in the form of glass wool loose fill fibres, into an inlet of a spraying apparatus; and
simultaneously projecting the glass wool fibres, water, the fire-resistance enhancer, optionally the intumescent fire-resistant component, and the organic binder from a spraying nozzle of the spraying apparatus towards a support surface so as to provide the sprayed layer of the glass wool insulation on the support surface.
   Preferably a primer bonding layer is applied to the support surface in advance; this facilitates long term adherence of the sprayed layer to the support surface. The quantity of primer bonding layer may be at least 80 g/cm², preferably 100 g/cm², more preferably at least 120 g/cm²; this provides suitable adherence. The quantity of primer bonding layer may be less than 160 g/cm², preferably less than 140 g/cm²; addition quantities do not provide significantly better adherence.
   The support surface may be a wall or ceiling, for example of a cellar, of a car park or of a crawl space underneath a building. Alternatively, the support surface may be a structural beam of a building, for example a structural metal beam of a building. During the spraying process, the distance between the spraying nozzle and the support surface is preferably in the range 0.5-3 m.

When the glass wool insulation is a sprayed layer of glass wool insulation the organic binder, the fire-resistance enhancer and the optional intumescent fire-resistant component are preferably provided pre-mixed with the glass wool fibres. In this way, the glass wool fibres comprising the organic binder, the fire-resistance enhancer and the optional intumescent fire-resistant component may be introduced into the inlet of the spraying apparatus and projected with water from the spraying nozzle of the spraying apparatus. This avoids the need for on-site dosing or mixing of the organic binder, the fire-resistance enhancer and the optional intumescent fire-resistant component. Thus, in accordance with another aspect, the present invention provides a package of glass wool fibres for introduction into a spraying apparatus and projection with water to form a sprayed layer of glass wool insulation as disclosed herein, the package of glass wool fibres comprising:
the collection of intermingled glass fibres in the form of glass wool, the glass wool having a structure formed from the intermingled glass fibres and air-filled interstices between the intermingled glass fibres, the glass fibres being present in the package in a quantity of at least 70% wt;
the organic binder, the organic binder being distributed within the glass wool structure and serving, once sprayed with the glass fibres, to retain the collection of intermingled glass fibres in the form of glass wool;
the fire-resistance enhancer, distributed within the glass wool structure, preferably distributed homogeneously within the glass wool structure; and
optionally, the intumescent fire-resistant component distributed within the glass wool structure, preferably distributed homogeneously within the glass wool structure. Alternatively, one or more of the organic binder, the fire-resistance enhancer and the optional intumescent fire-resistant component may be mixed with the water that is used in the spraying process.

The glass wool insulation may be a self-supporting glass wool insulation panel. As used herein, the term “self-supporting insulation panel” means a panel which is able to support its own weight so that it can be manually handled and installed without breaking apart. The self-supporting glass wool insulation panel may be provided into form of a slab, notably a slab having a length in the range 80-140 cm and a width in the range 60-100 cm. Alternatively, the self-supporting glass wool insulation panel may be provided in the form of a roll, notably a roll having a length greater than 200 cm and a width in the range 60-100 cm, which is intended to be cut to a desired length when installed. The self-supporting glass wool insulation panel is preferably secured to or within a supporting structure of a building, for example secured to a supporting wall or ceiling of a building or secured within a cavity of a cavity wall. One particularly preferred use for the self-supporting glass wool insulation panel is within the cavity of a partition wall of a building; in this application, the glass wool insulation panel provides desired levels of thermal and acoustic insulation combined with advantageous levels of fire resistance. The optional organically binder is preferably included for a self-supporting glass wool insulation panel, preferably in an amount of 2-8% wt with respect to the glass fibres. The binder is preferably a no-added formaldehyde binder, for example a sugar-based binder (that is to say a binder which is the reaction product(s) of a binder solution whose solid content comprises at least 50 wt % sugar(s)). Alternatively, the binder may be a urea extended formaldehyde-based binder; urea extended formaldehyde-based binder binders are industry standard mineral wool binders.

Thus, in accordance with a further aspect, the present invention provides a method of providing glass wool insulation as disclosed herein which is a self-supporting glass wool insulation panel, the method comprising:
providing the glass fibres in the form of a stream of glass fibres carried in an air-stream;
spraying the fire-resistance enhancer, optionally the intumescent fire-resistant component, and the organic binder towards the stream of glass fibres;
subsequently, separating the glass fibres from the air stream to form a batt of glass wool fibres comprising the glass fibres, the fire-resistance enhancer, optionally the intumescent fire-resistant component, and the organic binder; and
subsequently passing the batt of glass wool fibres through a curing oven to cure the binder and provide the self-supporting glass wool insulation panel.

The fire-resistance enhancer and optional intumescent fire-resistant component may be combined with the organic binder to form a binder mixture comprising the fire-resistance enhancer and the optional intumescent fire-resistant component, and the binder mixture may then be applied to the glass fibres, notably as an aqueous binder solution carrying the fire-resistance enhancer and optional intumescent fire-resistant component. Alternatively, the organic binder may be sprayed towards the stream of glass fibres using one set of nozzles and the fire-resistance enhancer and the optional intumescent fire-resistant component may be sprayed separately towards the stream of glass fibres, for example using another set of nozzles.

The glass wool insulation may be blowing wool (also known as loose fill). The blowing wool may be:
i) introduced into an existing cavity of a wall, for example by drilling a pattern of spaced blowing holes, often at intervals of 0.7 m to 1.2 m, and blowing the blowing wool through the blowing holes into the cavity using a nozzle of a blowing machine;
ii) incorporated into a cavity of a pre-fabricated wall, door, timber frame or wooden structure, notably during its manufacture;
iii) used to provide insulation on a horizontal surface, for example between rafters on the floor or difficulty accessible attic space, notably using a nozzle of a blowing machine to blow the glass wool fibres to cover a surface.
   The optional organically binder is preferably not included for blowing wool; the blowing wool is preferably free of binder. Nevertheless, a small amount of organic binder may be included in the blowing wool, notably to carry and/or retain the fire-resistance enhancer and the optional intumescent fire-resistant component within the glass wool structure.

Thus, in accordance with another aspect, the present invention provides a method of providing glass wool insulation as disclosed herein which is blowing wool, the method comprising:
introducing the glass fibres, notably in the form of glass wool loose fill fibres, into an inlet of a blowing machine; and
simultaneously projecting the glass wool fibres, the fire-resistance enhancer and optionally the intumescent fire-resistant component, from a blowing nozzle of the blowing machine to provide a layer of the blowing wool.

When the glass wool insulation is a blowing wool, the fire-resistance enhancer and the optional intumescent fire-resistant component are preferably provided pre-mixed with the glass wool fibres. In this way, the glass wool fibres comprising the fire-resistance enhancer and the optional intumescent fire-resistant component may be introduced into the inlet of the blowing machine and projected from the blowing nozzle. This avoids the need for on-site dosing or mixing of the fire-resistance enhancer and the optional intumescent fire-resistant component with the glass wool fibres. Thus, in accordance with another aspect, the present invention provides a package of glass wool fibres for introduction into a blowing machine and projection from a blowing nozzle of the blowing machine to form glass wool insulation as disclosed herein in the form of a layer of blowing wool, the package of glass wool fibres comprising:
the collection of intermingled glass fibres in the form of glass wool, the glass wool having a structure formed from the intermingled glass fibres and air-filled interstices between the intermingled glass fibres, the glass fibres being present in the package in a quantity of at least 70% wt;
the fire-resistance enhancer, distributed within the glass wool structure, preferably distributed homogeneously within the glass wool structure; and
optionally, the intumescent fire-resistant component distributed within the glass wool structure, preferably distributed homogeneously within the glass wool structure.

An embodiment of the invention will now be described, by way of example only, with reference to the accompanying drawings of which:

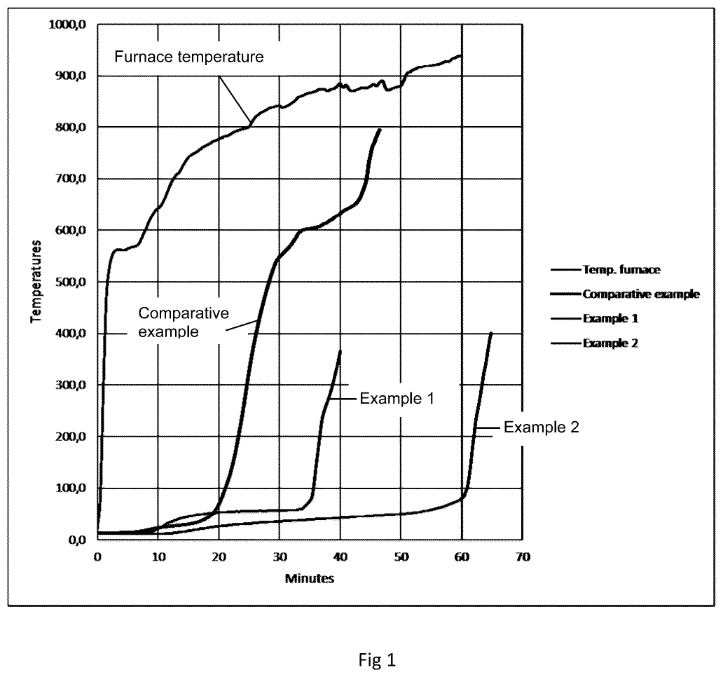

FIG. 1 is a graph of temperature during a glass wool insulation fire test;

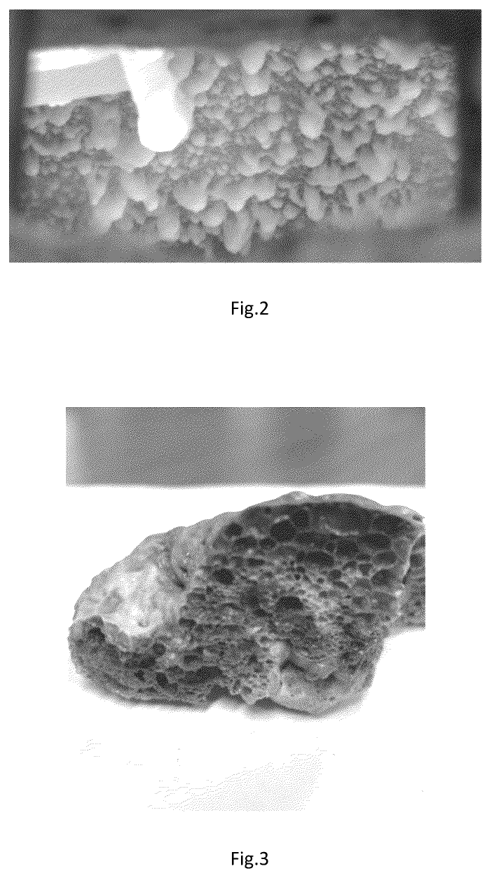

FIG. 2 is a picture of softening glass wool insulation during the fire test of Example 1; and

FIG. 3 is a picture of a cooled portion of glass from the fire test of Example 1.

A fire test was performed in respect of the sprayed glass wool insulation set out in Table A.

TABLE A

| | | Organic binder | Fire-resistance |
|---|---|---|---|
| | | (dispersible | enhancer |
| | Glass fibres (in | polymer binder of | (magnesium |
| | the form of glass | vinyl acetate and | hydroxide in |
| | wool) - parts per | ethylene) - parts | powder form) - |
| | weight | per weight | parts per weight |
| Comparative | 100 | 6 | 0 |
| example | | | |
| Example 1 | 100 | 6 | 3 |

The composition of the glass fibres was approximately (in % wt): SiO₂ 67.2; Na₂O 15.2; CaO 9.2; B₂O₃ 4.3; MgO 3.1; Al₂O₃0.7; K₂O 0.2; total iron (expressed as Fe₂O₃) 0.1; TiO₂<0.1; BaO<0.1. This composition of glass fibres is bio-soluble and Note Q compliant.

For example 1 the sprayed layer of glass wool insulation glass wool insulation consisted of 91.7% wt of glass fibres, 5.5% wt organic binder with respect to the glass fibres and 2.8% wt fire-resistance enhancer with respect to the glass fibres.

In each test, the example of Table A being tested was projected with water from a spraying nozzle to provide a 125 mm deep layer of sprayed glass wool insulation covering a primer treated surface of a concrete slab (length 1150 mm, width 550 mm). The surface of the concreter slab onto which the glass wool insulation was sprayed had, during casting of the concrete slab, been provided with a thermocouple.

Once sprayed, the sprayed layer of glass wool insulation at the surface of the concrete slab was allowed to dry for 3 weeks at room temperature (about 20° C. and 65% relative humidity). The density of the glass wool insulation (once dried) was about 50 kg/m³. The concrete slab was then arranged horizontally towards the top of a test furnace with the glass wool insulation facing downwards towards the interior of the furnace and the thermocouple at the surface of the concrete slab being shielded from the interior of the furnace by the sprayed layer of glass wool insulation.
Once the concrete slab shielded by the glass wool insulation had been installed in the furnace, the interior of the furnace was heated with gas burners to simulate fire conditions with a rising temperature in accordance with ISO 834 (target temperatures of: 576° C. after 5 minutes, 678° C. after 10 minutes, 781° C. after 20 minutes, 842° C. after 30 minutes, 885° C. after 40 minutes, 918° C. after 50 minutes and 945° C. after 60 minutes). The actual temperature within the interior of furnace (i.e. the temperature to which the lower surface of the glass wool insulation was exposed) was also measured with a thermocouple. Behaviour during each test was observed.

These tested reproduced the requirements of EN 13381-3 for determining the contribution to the fire resistance of structural members.

With the comparative example, the glass wool insulation started to detach from the concrete slab after about 20 minutes in the form of drops of glass which appeared to be formed from softening and agglomeration of the exposed glass fibres, once detachment started, it proceeded quickly with each subsequently exposed portion of the glass fibres. As can been seen in FIG. 2, once the glass wool insulation started to detach after about 20 minutes, the temperature at the portions of the concrete slab previously shielded by the glass wool insulation rose quickly.

With example 1, the glass wool insulation retained its integrity for a longer duration during the fire test; detachment of the exposed portions of the glass wool insulation only started after about 30 minutes and subsequently proceeded more slowly than with the comparative example. Unlike in the comparative example, in example 1 the softened glass, which appeared to be formed from agglomeration of the exposed glass fibres during the fire test, foamed and expanded. The softened, foamed form of glass remained in place longer than the softened droplets of glass observed with the comparative example. The softened foamed glass of example 1 appeared to flow less readily and remain attached to the remaining glass wool insulation for longer than the glass drops of the comparative example. This is thought to explain, at least in part, the improved fire resistance.

FIG. 3 shows (after cooling, subsequent to the fire test) a portion of foam glass which detached itself from the glass wool insulation of example 1. It is thought that incorporation of magnesium hydroxide into the softened mass of glass caused by agglomeration of exposed glass fibres, and subsequent release of water vapour from the magnesium hydroxide powder provoked the foaming of the softened glass. The lower density of the foamed glass and/or increased viscosity are thought to have reduced the tendency for the agglomerated softened glass once foamed to detach from the glass wool insulation, and the increased duration of the presence of the foamed glass at the glass wool insulation is thought to have delayed the time at which underlying portions of the glass wool insulation were exposed to the full heat of the furnace.

The presence of the fire-resistance enhancer in example 1 delayed the time during the test before the shielded thermocouple first recorded a temperature of about 400° C. by about 15 minutes.

1-28. (canceled)

29. A method of providing glass wool insulation, the glass wool insulation being a sprayed layer of glass wool insulation comprising:
a collection of intermingled glass fibres in the form of glass wool, the glass wool having a structure formed from the intermingled glass fibres and air-filled interstices between the intermingled glass fibres, the glass fibres being present in the glass wool insulation in a quantity of at least 70% wt with respect to the glass wool insulation;
an organic binder present in a quantity of less than 12% wt with respect to the glass fibres, the organic binder being distributed within the glass wool structure and serving to retain the collection of intermingled glass fibres in the form of glass wool; and
a fire-resistance enhancer, the fire-resistance enhancer being present in an amount of 1-15% wt with respect to the glass fibres and being distributed within the glass wool structure, in which the fire-resistance enhancer is selected from:
i) a gas generating fire retardant, the gas generating fire retardant being a material which releases a gas at a temperature between 400° C. and 900° C.; and
ii) a glass foaming agent, the glass foaming agent being a material which causes foaming of the glass of the glass wool when the glass wool insulation is subjected to a fire test in accordance with EN 1363-1 General requirements and the appropriate fire resistance standard selected as a function of the building structure, type of element or support surface to which the glass wool insulation is applied,
the method comprising:
introducing the glass fibres into an inlet of a spraying apparatus; and
simultaneously projecting the glass wool fibres, water, the fire-resistance enhancer, and the organic binder from a spraying nozzle of the spraying apparatus towards a support surface so as to provide the sprayed layer of the glass wool insulation on the support surface.

30. The method of claim 29, wherein the fire-resistance enhancer is provided in the form of particles.

31. The method of claim 29, wherein the fire-resistance enhancer is selected from the list consisting of magnesium hydroxide, calcium carbonate and combination thereof.

32. The method of claim 29, wherein the distribution of the fire-resistance enhancer is selected from the list consisting of homogeneously within the glass wool structure and homogeneously throughout the glass wool structure.

33. The method of claim 29, wherein the gas generating fire retardant is selected from the list consisting of hydromagnesite, magnesium hydroxide, brucite, huntite, dolomite, calcium carbonate and combination thereof.

34. The method of claim 29, wherein the glass foaming agent is selected from the list consisting of hydromagnesite, magnesium hydroxide, brucite, huntite, dolomite, calcium carbonate and combination thereof.

35. The method of claim 29, wherein the glass wool insulation further comprises an intumescent fire-resistant component distributed within the glass wool structure.

36. The method of claim 35, wherein the intumescent fire-resistant component is present in an amount in the range 2-8% wt with respect to the glass fibres.

37. The method of claim 35, wherein the intumescent fire-resistant component is selected from expandable graphite, expandable vermiculite, expandable perlite and combination thereof.

38. The method of claim 35, wherein the intumescent fire-resistant component is expandable graphite.

39. The method of claim 29, wherein the glass wool insulation has a fire reaction classification of at least B according to European Standard EN 13501-1.

40. The method of claim 29, wherein the glass wool insulation provides a fire resistance of at least 30 minutes in accordance with EN 1363-1 General requirements and the appropriate fire resistance EN standard selected as a function of the building structure, type of element or support surface to which the glass wool insulation is applied.

41. The method of claim 29, wherein the glass wool insulation has a density of at least 15 kg/m³ and of less than 100 kg/m³.

42. The method of claim 29, wherein the glass wool insulation has a thickness of at least 30 mm and less than 250 mm.

43. The method of claim 29, wherein the glass fibres have a composition comprising:
55 to 75 wt % SiO₂, and
5 to 20 wt % of the combination of Na₂O and K₂O, and
5 to 20 wt % of the combination of CaO and MgO, and
0 to 5 wt % Al₂O₃, and
0 to 2 wt % total iron expressed as Fe₂O₃, and
an alkali/alkaline-earth ratio which is >1.

44. The method of claim 29, wherein the glass fibres are glass fibres having a softening point which is less than 750° C. determined in accordance with International standards ISO 7884-1 and ISO 7884-2.

45. The method of claim 29, wherein the glass wool insulation has a lambda value (measured at 10° C.) in the range 30-38 mW/m·K.

46. The method of claim 29, wherein the organic binder is present in an amount with respect to the glass fibres of 2 to 10% wt.

47. The method of claim 29, wherein the standards are selected from the list consisting of EN 1364 series, EN 1364-1, the EN 1365 series, EN 1365-1, EN 1365-2, EN 1365-3, EN 1365-4, the EN 13381 series, EN 13381-3, EN 13381-4, EN 13381-5, EN 13381-6 and EN 13381-7

48. The method of claim 29, wherein the fire-resistance enhancer is carried by the organic binder.

49. A method of providing glass wool insulation, the glass wool insulation being a sprayed layer of glass wool insulation, the method comprising:
a collection of intermingled glass fibres in the form of glass wool, the glass wool having a structure formed from the intermingled glass fibres and air-filled interstices between the intermingled glass fibres, the glass fibres being present in the glass wool insulation in a quantity of at least 70% wt with respect to the glass wool insulation;
an organic binder present in a quantity of 2 to 10% wt with respect to the glass fibres, the organic binder being distributed within the glass wool structure and serving to retain the collection of intermingled glass fibres in the form of glass wool;
a fire-resistance enhancer, the fire-resistance enhancer being present in an amount of 1-15% wt with respect to the glass fibres and being distributed within the glass wool structure, wherein the fire-resistance enhancer is distributed homogeneously throughout the glass wool structure, and in which the fire-resistance enhancer is selected from the list consisting of: hydromagnesite, magnesium hydroxide, brucite, huntite, dolomite, calcium carbonate and combination thereof, and
an intumescent fire-resistant component present in an amount in the range 2-8% wt with respect to the glass fibres distributed within the glass wool structure, wherein the intumescent fire-resistant component is expandable graphite;
the method comprising:
introducing the glass fibres into an inlet of a spraying apparatus; and
simultaneously projecting the glass wool fibres, water, the fire-resistance enhancer, the intumescent fire-resistant component, and the organic binder from a spraying nozzle of the spraying apparatus towards a support surface so as to provide the sprayed layer of the glass wool insulation on the support surface.
